(19) United States
(12) Patent Application Publication
(10) Pub. No.: US 2013/0216957 A1
(43) Pub. Date: Aug. 22, 2013

(54) WATER-SOLUBLE RESIN COMPOSITION FOR FORMING FINE PATTERNS AND METHOD OF FORMING FINE PATTERNS BY USING THE SAME

(71) Applicants: Korea Kumho Petrochemical Co., Ltd., (US); Sang Wook Park, (US); Jong Jin Jeon, (US)

(72) Inventors: Sang Wook PARK, Chungcheongnam-do (KR); Jong Jin Jeon, Chungcheongnam-do (KR)

(73) Assignees: Sang Wook Park, Chungcheongnam-do (KR); Korea Kumbo Petrochemical Co., Ltd., Seoul (KR); Jong Jin Jeon, Chungcheongnam-do (KR)

(21) Appl. No.: 13/723,407

(22) Filed: Dec. 21, 2012

(30) Foreign Application Priority Data
Dec. 23, 2011 (KR) 10-2011-0141583

(51) Int. Cl. C09D 145/00; B05D 3/02

(52) U.S. Cl. CPC C09D 145/00; B05D 3/0254
USPC 430/325; 524/553; 427/385.5

(57) ABSTRACT

The water-soluble resin composition for forming fine patterns comprises a water-soluble polymer represented by Chemical Formula 1 and a first water-soluble solvent. The composition is coated and heated on a photoresist layer having contact holes to reduce a size of the contact holes.

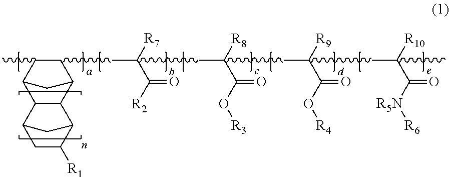

### CROSS-REFERENCE TO RELATED APPLICATIONS

This application claims the benefit of Korean Patent Application No. 10-2011-0141583, filed on Dec. 23, 2011, in the Korean Intellectual Property Office, the disclosure of which is incorporated herein by reference.

### BACKGROUND

1. Field of the Invention

The presented techniques are related to a resin composition for forming fine patterns and a method of stably forming a fine pattern in a semiconductor process by using the resin composition as a coating layer of a photoresist.

2. Description of the Related Art

Development is accelerated by a trend of high quality and a high integration of semiconductor devices, and by development of the lithography processes. According to above trend and development, a chemically amplified photoresist corresponding to a miniature of deign rule is also developed. However, in general, minimum resolution realized by using an ArF exposure apparatus is about 0.05 μm. Therefore, it is difficult to manufacture high integrated semiconductor devices that need fine patterns, and then variable methods are considered to overcome above problems.

As an example method that is widely used by this time includes a resist thermal reflow method allowing liquidity to a photoresist by heat-treating to the photoresist. By this method, a size of a contact hole may be reduced by heat-treating the photoresist at a temperature over a glass transition temperature of the photoresist after the contact hole is formed on the photoresist. However, by this method, a top-rounding and an undercut are generated, so that a control of critical dimension may be difficult.

Therefore, it became important that a cross-linkage reaction is generated at a boundary surface between functional materials and contact hole of a photoresist by coating the functional materials on the contact hole of the photoresist to reduce a size of the contact hole-pattern. Also, the coating materials are needed to endure an etching gas when the photoresist pattern coated by the functional materials is etched by the etching gas.

Another method that used to overcome the above method may include using a functional materials such as RELACS (manufactured by CLARIRANT Co., Switzerland) and SAFIER (manufactured by TOKYO OHKA KOGYO CO., LTD., Japan) to reduce a size of the pattern.

The method using a functional materials lead to a cross linkage between the functional materials and the photoresist an interface in that the size of the contact hole may be reduced. However, the method using the functional materials needs to repeat cross linkage process at least a several times to decrease efficiency. Also, the functional materials are poor at an anti-etching characteristic because they don't have a bulky portion in the polymer. Furthermore, the method above is insufficient to meet a coating characteristic required to the pattern, and it is difficult to control a thickness of the cross-linkage under the heat-treating process.

### SUMMARY

An exemplary embodiment of the present invention, a water-soluble polymer represented by Chemical Formula 1 as below and a first water-soluble solvent, and the water-soluble resin composition is coated and heated on a photoresist layer having contact holes to reduce a size of the contact holes.

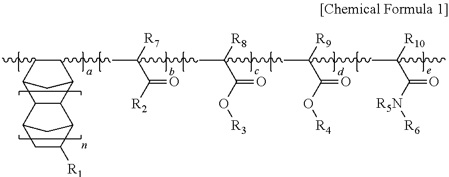

In Chemical Formula 1, each of R₁, R₂, R₃, R₄ and R₆ independently represents of a hydrogen atom, a hydroxyl group, a compound of C₁₋₃₀ or a cyclo compound of C₃₋₃₀ which respectively has one functional group selected from the group consisting of an ether group, an ester group, a carbonyl group, an acetal group, an epoxy group, a nitrile group, an amine group, and an aldehyde group (R₃≠R₄); each of R₅, R₇, R₈, R₉ and R₁₀ independently represents a hydrogen atom or a methyl group; n represents an integer of 0 to 5; a represents a real number of 0.05 to 0.5; each of b, c and d respectively represents a real number of 0 to 0.7; and a+b+c+d+e=1.

The water-soluble solvent comprises about 100 parts by weight of water and about 1 to about 20 parts by weight of an alcohol. The water-soluble resin composition comprise about 100 parts by weight of the water-soluble solvent and about 0.01 to about 15 parts by weight of the water-soluble polymer.

The alcohol may comprise an alkoxy alcohol.

The water-soluble polymer has about 3,000 to about 50,000 of polystyrene-referenced weight-average molecular weight (Mw) by Gel-permeation chromatography (GPC).

The water-soluble polymer has about 1.0 to about 5.0 of molecular weight distribution (weight-average molecular weight/number-average molecular weight).

Another exemplary embodiment of the present invention, a method of forming fine pattern comprising forming a photoresist layer, forming a contact hole on the photoresist layer by photolithography method to prepare a photoresist pattern layer, coating water-soluble resin composition of claim 1 on the photoresist pattern layer, heat-treating the photoresist pattern layer coated by the water-soluble resin composition to form a coating layer having cross-linked part, and applying the second water-soluble solvent to the coating layer for removing the coating layer except the cross-linked part.

The second water-soluble solvent may comprise water.

The heat-treating of the photoresist pattern layer is preferably performed at a temperature of about 100° C. to about 200° C. A size of the contact hole is adjusted to a temperature of the heat-treating.

The photoresist layer includes norbornene derivatives, and the photoresist layer comprises a non-water-soluble layer.

### EFFECT

According to exemplary embodiment, the water-soluble resin composition allows fine contact hole less than about 0.05 μm to be formed in the semiconductor process. Also the water-soluble resin composition may reduce defects of the structure such as a top rounding and undercut to increase a miniature and a stability of the semiconductor device including variable patterns.

According to another exemplary embodiment of the method, a photoresist layer having fine contact holes is effectively and stably manufactured.

### DETAILED DESCRIPTION

Hereinafter, a resin composition according to exemplary embodiments will be described in detail.

The water-soluble resin composition according to an embodiment of the invention comprises polymer of Formula 1 and water-soluble solvent.

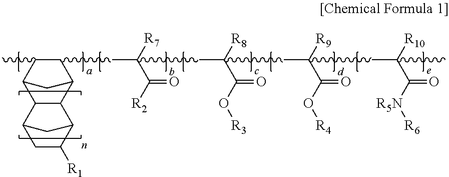

In Chemical Formula 1, each of R₁, R₂, R₃, R₄ and R₆ independently represents of a hydrogen atom, a hydroxyl group, a compound of C₁₋₃₀ or a cyclo compound of C₃₋₃₀ which respectively has one functional group selected from the group consisting of an ether group, an ester group, a carbonyl group, an acetal group, an epoxy group, a nitrile group, an amine group, and an aldehyde group (R₃≠R₄);

each of R₅, R₇, R₈, R₈ and R₁₀ independently represents a hydrogen atom or a methyl group;

n represents an integer of 0 to 5;

a represents a real number of 0.05 to 0.5;

each of b, c and d respectively represents a real number of 0 to 0.7;

and a+b+c+d+e=1.

The polymer represented by Formula 1 comprises a repeating unit (a) having norbornene derivatives. The norbornene derivatives have a characteristic of deriving the polymer of Formula 1 to copolymer having a modified spiral structure. A problem of poor solubility in conventional methacrylate based copolymer can be improvement due to the norbornene derivatives in the resin composition according to the invention. Furthermore, there has been difficult to adjust a molecular weight of the conventional methacrylate based copolymer while polymerization and to synthesize polymer having a low molecular weight. However, in the polymer of Formula 1, the repeating unit (a) of the norbornene derivatives has a function of adjusting a molecular weight substantially such that it can be able to adjust polymerization and synthesis polymer having a low molecular weight. Furthermore, the repeating unit (a) of the norbornene derivatives has an aromatic structure to enhance each-resistance.

Examples according to the polymer represented by Formula 1 are described to copolymers of the following Chemical Formula 2 to Chemical Formula 16.

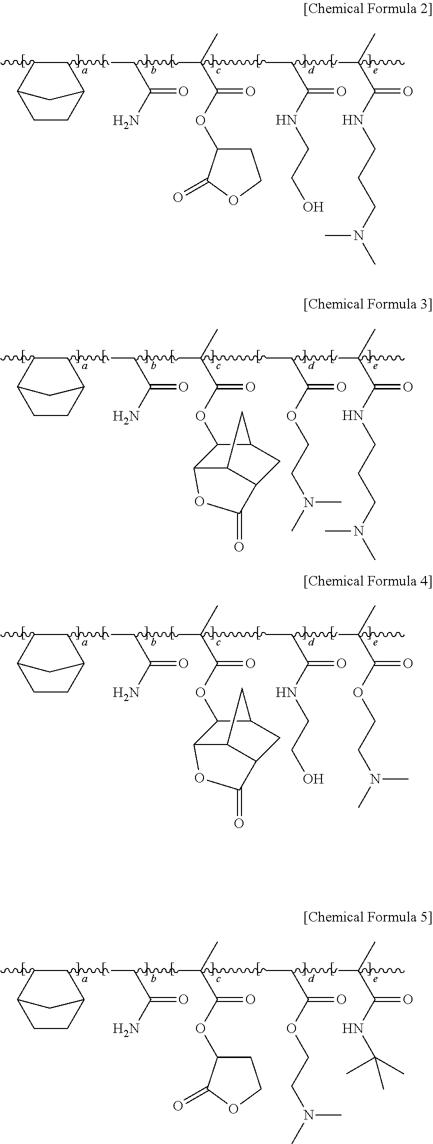

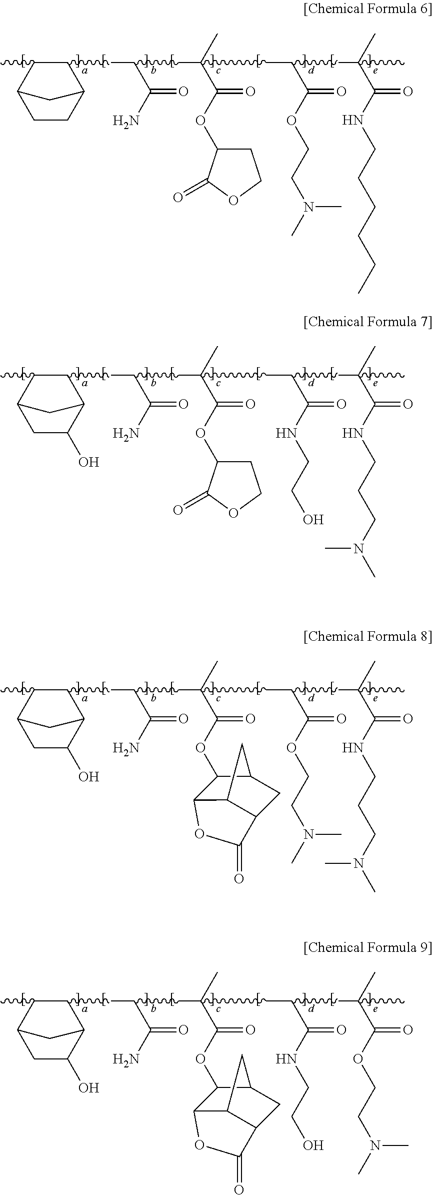

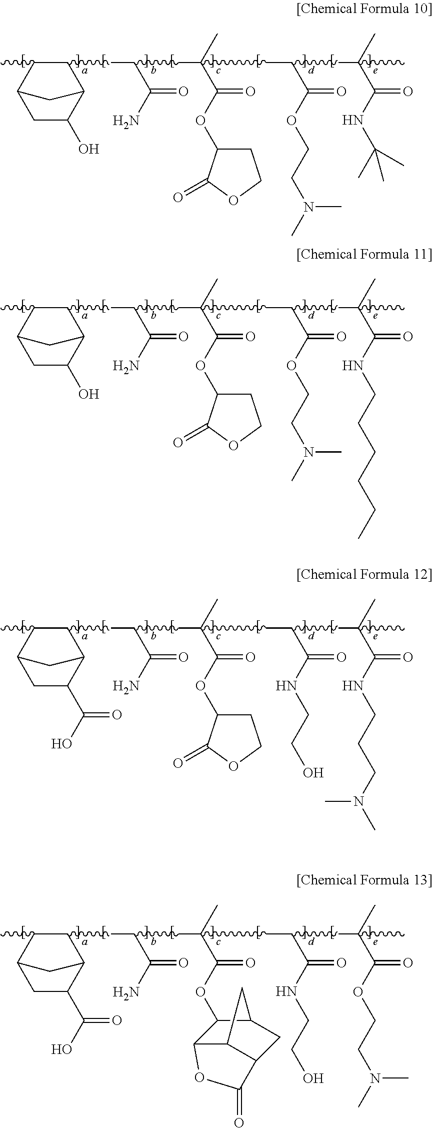

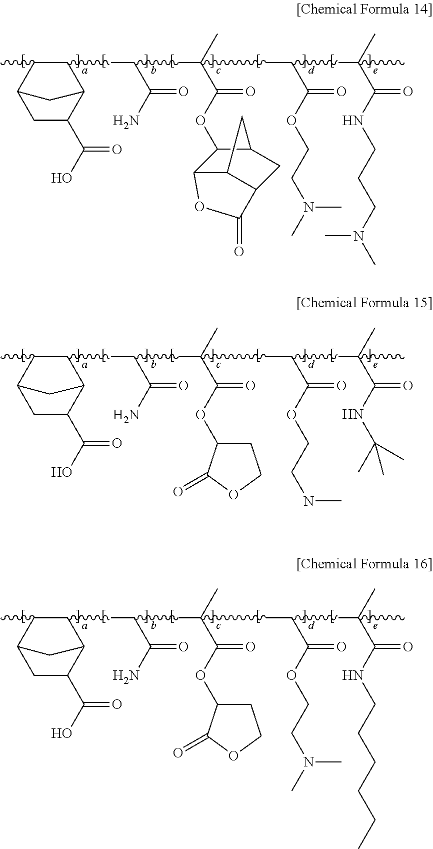

Each of the copolymers represented by Chemical Formula 1 to Chemical Formula 16 may be block copolymer, random copolymer or graft copolymer. The polymers are formed by the conventional polymerization methods, radical polymerization in particular. As an initiator of radical polymerization, azobisisobutyrontrile (AIBN), benzoyl peroxide (BPO), lauroyl peroxide, azobisisocapronitrile, azobisisovaleronitrile, t-butyl hydroperoxide or the like may be used, but the invention is not limited by a kind of the initiator of radical polymerization. A method of polymerization ma comprise, for example, bulk polymerization, solution polymerization, suspension polymerization, bulk suspension polymerization, emulsion polymerization or the like. Furthermore, a polymerization solvent may be, for example, benzene, toluene, xylene, Halogenated benzene, diethyl ether, tetrahydrofuran, esters, ethers, lactones, ketones, amides, alcohols and so on. Each of the polymerization solvents or a mixture of at least two of the polymerization solvents may be used.

Polymerization temperature may be set properly according to a kind of catalyst. Distribution of molecular weight of the polymer may be adjusted properly according to usage and reaction time of polymerization initiator. After polymerization is finished, unreacted monomers and byproducts in a reaction mixture may be removed by the solvent precipitation.

Polystyrene-referenced weight-average molecular weight (Mw) of the polymer according to gel-permeation chromatography (GPC) is from about 2,000 to about 1,000,000, particularly from about 3,000 to about 50,000 when properties of photoresist such as sensitivity, a developing property, a coating property, thermal endurance or the like are considered. Furthermore, the distribution of molecular weight of the polymer is from about 1.0 to about 5.0, specifically from about 1.0 to about 3.0.

In an embodiment of the invention, a mixture of alcohol and water may be used as the water-soluble solvent. In particular, the alcohol may be C_{1˜10} alkyl alcohol or C_{1˜10} alkoxy alcohol. The water-soluble solvent may contain about 1 to about 20 parts by weight of alcohol to about 100 parts by weight of water. When the water-soluble solvent contains less than 1 parts by weight of the alcohol, an effect of promoting dissolution is reduced. When the water-soluble solvent contains more than about 20 parts by weight of the alcohol, it is difficult to form a coating layer.

The alcohol may be alkyl alcohol such as, for example, methanol, ethanol, propanol, isopropanol, n-butanol, see-butanol, t-butanol, 1-pentanol, 2-pentanol, 3-pentanol, 2,2-dimethyl group-propanol and so on; alkoxy alcohol, such as 2-methoxy ethanol, 2-(2-methoxyethoxy)ethanol, 1-methoxy-2-propanol, 3-methoxy1,2-propandiol and so on. Each of the alcohols or a mixture of At least two alcohol may be used.

Furthermore, the water-soluble resin composition may contain about 0.01 to about 15 parts by weight of the water-soluble polymer of solid contents to 100 parts by weight of the water-soluble solvent in particular. When the water-soluble polymer is contained less than about 0.01 parts by weight in the water-soluble resin composition, a coating property is reduced to be insufficient to form a coating layer of the photoresist. When the water-soluble polymer is contained more than about 15 parts by weight in the water-soluble resin composition, a uniformity of the coated layer may be reduced.

The said water-soluble resin composition is coated on a wafer substrate having the photoresist pattern with at least one contact hole and the wafer substrate coated with the water-soluble resin composition is dried to form a film. After filtering the water-soluble resin composition, the filtered solution may be coated on the photoresist pattern by the method of spin coating, flow coating, roller coating and so on. The coated water-soluble resin composition is heat-treated to form a layer with at least one cross-linked part. In other words, the layer with at least one cross-linked part is form by baking a photoresist of the coated water-soluble resin composition to reduce the size of contact hole. Furthermore, the other part that is not cross-linked part in the layer is removed by the water-soluble solvent such as water and so on.

A thickness of the layer with at least one cross-linked part may be controlled according to the heat-treating temperature. Furthermore, the size of the contact hole may be controlled according to the thickness of the layer.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

### Synthesis of the Water-Soluble Polymer

### Synthesis Example 1

500 ml 3-neck flask was charged with 10.0 g of monomer acrylamide for polymerization, 7.3 g of hydroxyethylacrylamide, 9.5 g of γ-butyrolactyl methacrylate and 10.1 g of dimethyl aminopropyl methacrylamide, and those are dissolved in 40.9 g of 1,4-dioxane. 250 ml flask was charged with 4.0 g of norbornene and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a first water-soluble polymer of Formula 2 was collected (28.7 g, 70.2% yield). Polystyrene-referenced weight-average molecular weight (Mw) of the first water-soluble polymer was 8,800 of and a ratio of weight-average molecular weight to number-average molecular weight (Mw/Mn) thereof was 2.85.

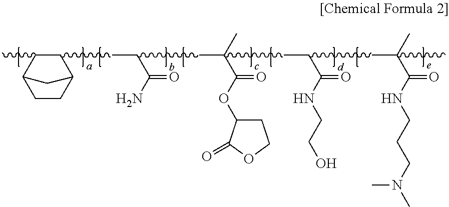

### Synthesis Example 2

500 ml 3-neck flask was charged with 11.2 g of monomer acrylamide for polymerization, 8.9 g of 5-methacryloyloxy-2,6-norbornane carbolactone, 7.3 g of dimethylaminoethylacrylate and 10.1 g of dimethylaminopropylmethacrylamide, and those are dissolved in 41.5 g of 1,4-dioxane. 250 ml flask was charged with 4.0 g of norbornene and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a second water-soluble polymer of Formula 3 was collected (29.9 g, 72.0% yield). Polystyrene-referenced weight-average molecular weight (Mw) of the second water-soluble polymer was 8100 of and a ratio of weight-average molecular weight to number-average molecular weight (Mw/Mn) thereof was 2.81.

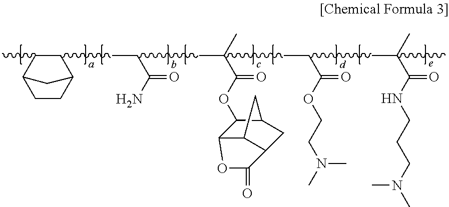

### Synthesis Example 3

500 ml 3-neck flask was charged with 10.0 g of monomer acrylamide for polymerization, 9.5 g of hydroxyethylacrylamide, 8.1 g of 5-methacryloyloxy-2,6-norbornane carbolactone and 10.1 g of dimethylaminoethylmethacrylate, and those are dissolved in 41.7 g of 1,4-dioxane. 250 ml flask was charged with 4.0 g of norbornene and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a third water-soluble polymer of Formula 4 was collected (30.1 g, 72.2% yield). Polystyrene-referenced weight-average molecular weight (Mw) of the third water-soluble polymer was 8,300 of and a ratio of weight-average molecular weight to number-average molecular weight (Mw/Mn) thereof was 2.75.

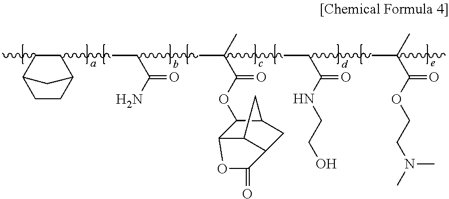

### Synthesis Example 4

500 ml 3-neck flask was charged with 15.4 g of monomer acrylamide for polymerization, 7.3 g of γ-butyrolactyl methacrylate, 4.3 g of dimethylaminoethylacrylate and 10.0 g of tert-butylmethacrylamide, and those are dissolved in 41.0 g of 1,4-dioxane. 250 ml flask was charged with 4.0 g of norbornene and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a forth water-soluble polymer of Formula 5 was collected (28.8 g, 70.2% yield). Polystyrene-referenced weight-average molecular weight (Mw) of the forth water-soluble polymer was 7,600 of and a ratio of weight-average molecular weight to number-average molecular weight (Mw/Mn) thereof was 2.99.

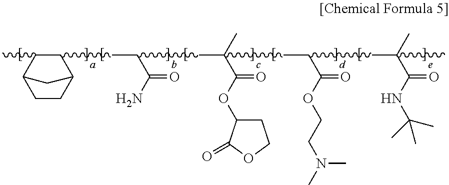

### Synthesis Example 5

500 ml 3-neck flask was charged with 7.3 g of monomer acrylamide for polymerization, 10.0 g of γ-butyrolactylmethacrylate, 9.5 g of dimethylaminoethylacrylate and 10.0 g of n-hexylmethacrylamide, and those are dissolved in 40.9 g of 1,4-dioxane. 250 ml flask was charged with 4.0 g of norbornene and 2.0 g of dimethylazobisisobutylate of a polymerization initiator, and those are dissolved in 94.2 g of 1,4-dioxane. The a solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a fifth water-soluble polymer of Formula 6 was collected (29.9 g, 73.1% yield). Polystyrene-referenced weight-average molecular weight (Mw) of the fifth water-soluble polymer was 8,400 of and a ratio of weight-average molecular weight to number-average molecular weight (Mw/Mn) thereof was 2.76.

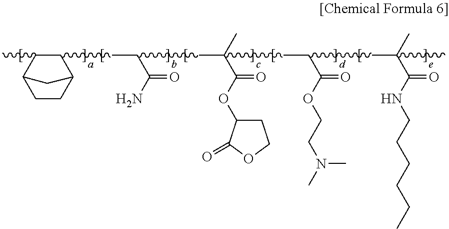

### Synthesis Example 6

500 ml 3-neck flask was charged with 10.0 g of monomer acrylamide for polymerization, 7.3 g of hydroxyethylacrylamide, 9.3 g of γ-butyrolactylmethacrylate and 10.1 g of dimethylaminopropylmethacrylamide, and those are dissolved in 40.7 g of 1,4-dioxane. 250 ml flask was charged with 4.0 g of norbornene and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a sixth water-soluble polymer of Formula 7 was collected (30.9 g, 75.9% yield). Polystyrene-referenced weight-average molecular weight (Mw) of the sixth water-soluble polymer was 7,800 of and a ratio of weight-average molecular weight to number-average molecular weight (Mw/Mn) thereof was 2.98.

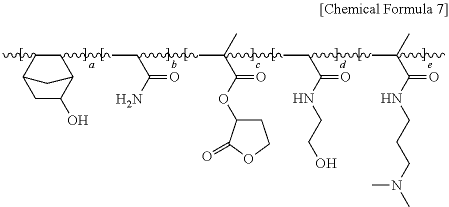

### Synthesis Example 7

500 ml 3-neck flask was charged with 10.0 g of monomer acrylamide for polymerization, 8.0 g of 5-methacryloyloxy-2,6-norbornane carbolactone, 10.1 g of dimethylaminoethylacrylate and 8.5 g of dimethylaminopropylmethacrylamide, and those are dissolved in 40.6 g of 1,4-dioxane. 250 ml flask was charged with 4.0 g of norbornene and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a seventh water-soluble polymer of Formula 8 was collected (32.1 g, 79.1% yield). Polystyrene-referenced weight-average molecular weight (Mw) of the seventh water-soluble polymer was 7,900 of and a ratio of weight-average molecular weight to number-average molecular weight (Mw/Mn) thereof was 2.81.

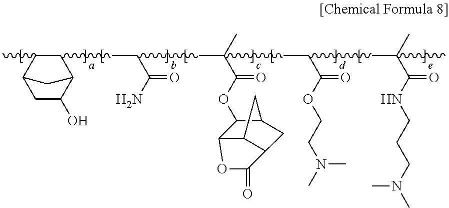

### Synthesis Example 8

500 ml 3-neck flask was charged with 10.0 g of monomer acrylamide for polymerization, 10.1 g of hydroxyethylacrylamide, 9.0 g of 5-methacryloyloxy-2,6-norbornane carbolactone and 7.9 g of dimethylaminoethylmethacrylate, and those are dissolved in 41.0 g of 1,4-dioxane. 250 ml flask was charged with 4.0 g of 5-norbornene-2-ol and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that the eighth water-soluble polymer of Formula 9 was collected (33.2 g, 81% yield). Polystyrene-referenced weight-average molecular weight (Mw) of the eighth water-soluble polymer was 8,600 of and a ratio of weight-average molecular weight to number-average molecular weight (Mw/Mn) thereof was 2.99.

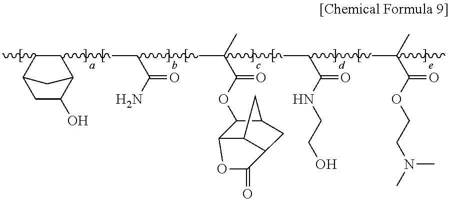

### Synthesis Example 9

500 ml 3-neck flask was charged with 10.0 g of monomer acrylamide for polymerization, 8.8 g of γ-butyrolactylmethacrylate, 8.5 g of dimethylaminoethylacrylate and 9.2 g of tert-butylmethacrylamide, and those are dissolved in 40.5 g of 1,4-dioxane. 250 ml flask was charged with 4.0 g of 5-norbornene-2-ol and 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a ninth water-soluble polymer of Formula 10 was collected (29.0 g, 71.6% yield). Polystyrene-referenced weight-average molecular weight (Mw) of the ninth water-soluble polymer was 7,700 of and a ratio of weight-average molecular weight to number-average molecular weight (Mw/Mn) thereof was 2.76.

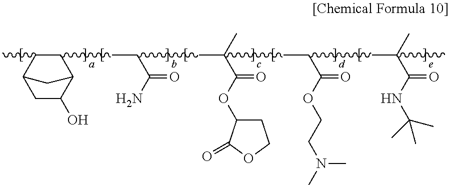

### Synthesis Example 10

500 ml 3-neck flask was charged with 9.5 g of monomer acrylamide for polymerization, 9.9 g of γ-butyrolactylmethacrylate, 9.5 g of dimethylaminoethylacrylate and 7.8 g of n-hexylmethacrylamide, and those are dissolved in 40.7 g of 1,4-dioxane. 250 ml flask was charged with 4.0 g of 5-norbornene-2-ol 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a tenth water-soluble polymer of Formula 11 was collected (29.3 g, 72% yield). Polystyrene-referenced weight-average molecular weight (Mw) of the ninth water-soluble polymer was 7,800 of and a ratio of weight-average molecular weight to number-average molecular weight (Mw/Mn) thereof was 2.98.

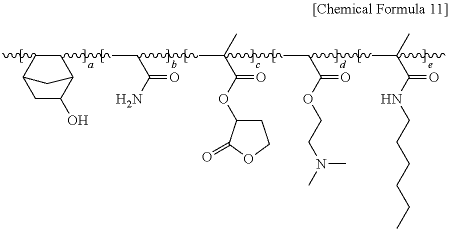

### Synthesis Example 11

500 ml 3-neck flask was charged with 8.5 g of monomer acrylamide for polymerization, 10.5 g of hydroxyethylacrylamide, 9.0 g of γ-butyrolactylmethacrylate, and 8.5 g of dimethylaminoethylacrylate, and those are dissolved in 40.5 g of 1,4-dioxane. 250 ml flask was charged with 4.0 g of 5-norbornene-2-carboxylic 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a tenth water-soluble polymer of Formula 12 was collected (30.8 g, 76% yield). Polystyrene-referenced weight-average molecular weight (Mw) of the ninth water-soluble polymer was 8,500 of and a ratio of weight-average molecular weight to number-average molecular weight (Mw/Mn) thereof was 2.84.

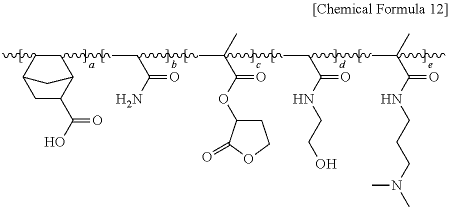

### Synthesis Example 12

500 ml 3-neck flask was charged with 10.1 g of monomer acrylamide for polymerization, 8.5 g of hydroxyethylacrylamide, 9.1 g of 5-methacryloyloxy-2,6-norbornane carbolactone, and 9.3 g of dimethylaminoethylacrylate, and those are dissolved in 41.0 g of 1,4-dioxane. 250 ml flask was charged with 4.0 g of 5-norbornene-2-carboxylic acid, 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a tenth water-soluble polymer of Formula 13 was collected (33.2 g, 81.0% yield). Polystyrene-referenced weight-average molecular weight (Mw) of the ninth water-soluble polymer was 7900 of and a ratio of weight-average molecular weight to number-average molecular weight (Mw/Mn) thereof was 2.75.

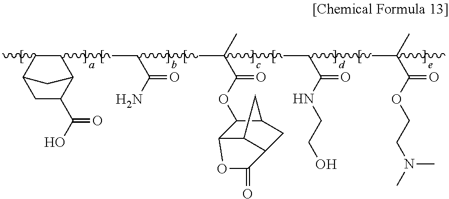

### Synthesis Example 13

500 ml 3-neck flask was charged with 8.5 g of monomer acrylamide for polymerization, 10.1 g of 5-methacryloyloxy-2,6-norbornane carbolactone, and 8.5 g of dimethylaminoethylacrylate, and those are dissolved in 40.9 g of 1,4-dioxane. 250 ml flask was charged with 4.0 g of 5-norbornene-2-carboxylic acid 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a tenth water-soluble polymer of Formula 14 was collected (31.5 g, 77.0% yield). Polystyrene-referenced weight-average molecular weight (Mw) of the ninth water-soluble polymer was 8000 of and a ratio of weight-average molecular weight to number-average molecular weight (Mw/Mn) thereof was 2.94.

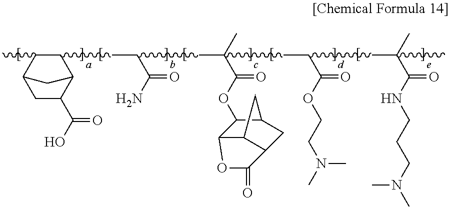

### Synthesis Example 14

500 ml 3-neck flask was charged with 9.0 g of monomer acrylamide for polymerization, 9.8 g of γ-butyrolactylmethacrylate, 9.6 g of dimethylaminoethylacrylate, 9.1 g of tert-butylmethacrylamide, and those are dissolved in 41.5 g of 1,4-dioxane. 250 ml flask was charged with 4.0 g of 5-norbornene-2-carboxylic acid 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a tenth water-soluble polymer of Formula 15 was collected (30.1 g, 72.5% yield). Polystyrene-referenced weight-average molecular weight (Mw) of the ninth water-soluble polymer was 8100 of and a ratio of weight-average molecular weight to number-average molecular weight (Mw/Mn) thereof was 2.65.

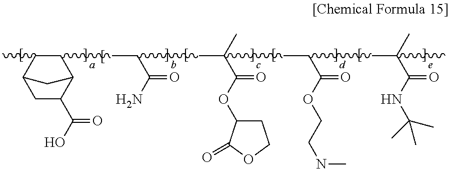

### Synthesis Example 15

500 ml 3-neck flask was charged with 10.6 g of monomer acrylamide for polymerization, 9.2 g of γ-butyrolactylmethacrylate, 10.1 g of dimethylaminoethylacrylate, 7.2 g of n-hexylmethacrylamide, and those are dissolved in 41.1 g of 1,4-dioxane. 250 ml flask was charged with 4.0 g of 5-norbornene-2-carboxylic acid 2.0 g of dimethylazobisisobutylate of a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 10 hours, a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a tenth water-soluble polymer of Formula 16 was collected (28.8 g, 70.1% yield). Polystyrene-referenced weight-average molecular weight (Mw) of the ninth water-soluble polymer was 7900 of and a ratio of weight-average molecular weight to number-average molecular weight (Mw/Mn) thereof was 2.94.

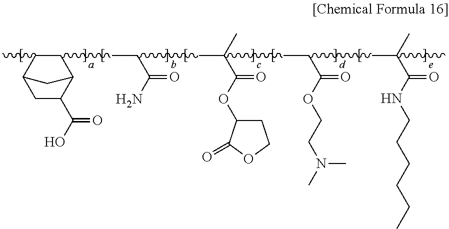

### Comparative Synthesis Example 1

For polymerization, 500 ml 3-neck flask was charged with 10.0 g of monomer acrylamide, 8.0 g of hydroxyethylacrylamide and 9.0 g of dimethylaminoethylmethacrylate, and those are dissolved in 31.0 g of 1,4-dioxane. After allowing to react at the room-temperature for 10 hours while maintaining a temperature of a reactor at 65° C., a reaction solution that polymerization was completed was cooled at the room-temperature. A large amount of n-hexane was added in the cooled reaction solution to precipitate. And precipitates were filtered. And then, the precipitated reaction solution was dried under reduced pressure after being washed many times with a single solvent such that a eleventh water-soluble polymer of Formula 17 was collected (15.9, 58.9% yield). Polystyrene-referenced weight-average molecular weight (Mw) of the ninth water-soluble polymer was 9,300 of and a ratio of weight-average molecular weight to number-average molecular weight (Mw/Mn) thereof was 3.42.

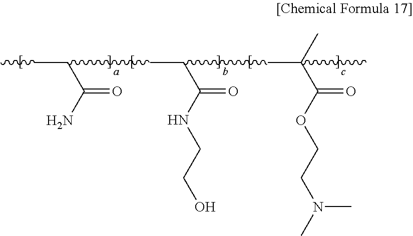

### Synthesis of Photoresist Resin

### Synthesis Example 16

10.0 g/7.3 g/10.1 g of 2-methyl 2-adamantyl methacrylate/γ-butyrolactylmethacrylate/3-hydroxy 1-adamantyl methacrylate as monomers for polymerization, was dissolved in 31.0.1 g of 1,4-dioxane. 250 ml flask was charged with 4.0 g of norbornene, 2.0 g of AIBN as a polymerization initiator, and those are dissolved in 94.2 g of 1,4-dioxane. The solution in the 250 ml flask was stirred under nitrogen (N₂) injection for one hour while maintaining room-temperature. While maintaining a temperature of a reactor at 65° C., a solution in the 250 ml flask was dropped slowly into a solution in the 500 ml 3-neck flask using a syringe pump for 1 hour. After allowing to react at the room-temperature for 16 hours, a reaction solution that polymerization was completed was cooled at the room-temperature. n-hexane was added in the cooled reaction solution to precipitate. And precipitates were filtered. And then, the precipitated reaction solution was dried under reduced pressure after being washed many times with a single solvent such that a tenth water-soluble polymer of Formula 18 was collected (21.1 g, 67.2% yield). Polystyrene-referenced weight-average molecular weight (Mw) of the ninth water-soluble polymer was 8800 of and a ratio of weight-average molecular weight to number-average molecular weight (Mw/Mn) thereof was 1.86.

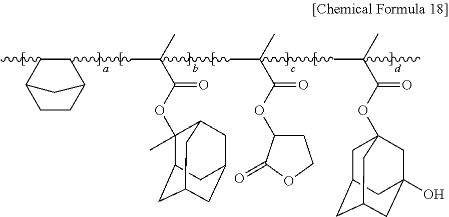

### Manufacture of Photoresist Layer and Evaluation

### Example 1

### Forming Contact Hole

100 parts by weight of The polymer acquired by Synthesis Example 16, 2.5 parts by weight of triphenyl sulfonium nonaflate as an acid generator, 0.75 part by weight of tetramethyl amoniumhydroxide 0.75 parts by weight as an alkaline additive were added into 1,000 parts by weight of the prophyleneglycol methyl ether acetate to form a film having a thickness of 0.2 μm. Acquired photoresist solution was doped on a substrate by using spinner, and then the solution was dried at a temperature of about 110° C. for 60 seconds to form a layer of 0.2 μm. The formed layer was exposed by ArF excimer laser stepper (numerical aperture; NA: 0.78) and then heat-treated at a temperature of 110° C. for 60 seconds. The heat-treated layer was developed by solution of tetramethyl ammonium hydroxide of 2.38 wt % for 40 seconds, and then washed and dried to for a contact hole pattern. A size of the contact hole was measured by Scanning Electron Microscope (SEM), and the measured size was 123.1 nm.

### Example 2

The resin of 3.0 g acquired by Synthesis Example 1 (Chemical Formula 2) was fully dissolved into a mixture of distilled water of 95.0 g and isopropylalcohol of 5.0 g, and then was filtered by a membrane filter of 0.2 μm to prepare a water-soluble resin composition (composition for coating the photoresist). The water-soluble resin composition was spin-coated on a wafer on which a contact hole pattern is formed to form coated thin layer. Then, the coated thin layer was heat-treated in an oven of 150° C. for 60 seconds to promote a cross-linking reaction. And the wafer coated with the composition was washed and rotated with deionized water for 60 seconds to remove a non-cross linked portion. The contact hole size measured by SEM was 87.6 mm, which showed that 35.5 mm was reduced from an initial size.

### Examples 3 to 11

Example 3 to 16 were identical to the Example 2 except the water soluble resin composition as described in table 2 as below. In the same manner of Example 2, each of the water-soluble resin composition of Examples 3 to 16 was spin-coated on the wafer on which the contact hole pattern was formed to form a thin layer, and then contact hole size was measured as that of Example 2.

### Comparative Example 1

Comparative Example 1 was identical to the Example 2 except the water soluble resin composition as described in table 2 as below. In the same manner of Example 2, the water-soluble resin composition of Comparative Examples 1 was spin-coated on the wafer on which the contact hole pattern was formed to form a thin layer, and then contact hole size was measured as that of Example 2.

All measured results are also represented in Table 1 below.

TABLE 1

| | | Contact hole size before | Contact hole size after | Reduced |
|---|---|---|---|---|
| Example | Polymer | composition was applied to | composition was applied to | size |
| Example 3 | Formula 3 | 123.1 nm | 89.1 nm | 34.0 nm |
| Example 4 | Formula 4 | 123.1 nm | 90.3 nm | 32.8 nm |
| Example 5 | Formula 5 | 123.1 nm | 91.5 nm | 31.6 nm |
| Example 6 | Formula 6 | 123.1 nm | 85.6 nm | 37.5 nm |
| Example 7 | Formula 7 | 123.1 nm | 90.8 nm | 32.3 nm |
| Example 8 | Formula 8 | 123.1 nm | 88.5 nm | 34.6 nm |
| Example 9 | Formula 9 | 123.1 nm | 91.9 nm | 31.2 nm |
| Example 10 | Formula 10 | 123.1 nm | 84.5 nm | 38.6 nm |
| Example 11 | Formula 11 | 123.1 nm | 89.5 nm | 33.6 nm |
| Example 12 | Formula 12 | 123.1 nm | 90.6 nm | 32.5 nm |
| Example 13 | Formula 13 | 123.1 nm | 91.1 nm | 32.0 nm |
| Example 14 | Formula 14 | 123.1 nm | 86.4 nm | 36.7 nm |
| Example 15 | Formula 15 | 123.1 nm | 83.6 nm | 39.5 nm |
| Example 16 | Formula 16 | 123.1 nm | 84.9 nm | 38.2 nm |
| Comparative | Formula 17 | 123.1 nm | 113.3 nm | 9.8 nm |
| Example 1 | | | | |

As known in table 1, a degree of reduced contact hole size of each Examples was remarkably excellent with comparison to that of Comparative Example 1.

### Examples 17

### Measurement of Etching Tolerance

As to Example 2 to 16 and Comparative Example 1, etching tolerance of wafer of which contact hole size was reduced. TCP-9400DFM (Poly Chamber, LAM Co.) was used for dry typed etching, and the pressure of chamber was 15 mTorr. Etching was performed for 2 minutes and 30 seconds by CF₄ gas.

Etching Speed=[(thickness before)−(thickness after)/time]

Measured etching speed is described in table 2 as below.

TABLE 2

| | | Etching speed |
|---|---|---|
| Example | copolymer | (Å/minute) |
| Example 2 | Formula 2 | 585 |
| Example 3 | Formula 3 | 556 |
| Example 4 | Formula 4 | 555 |
| Example 5 | Formula 5 | 589 |
| Example 6 | Formula 6 | 585 |
| Example 7 | Formula 7 | 589 |
| Example 8 | Formula 8 | 562 |
| Example 9 | Formula 9 | 555 |
| Example 10 | Formula 10 | 581 |
| Example 11 | Formula 11 | 569 |
| Example 12 | Formula 12 | 569 |
| Example 13 | Formula 13 | 546 |
| Example 14 | Formula 14 | 540 |
| Example 15 | Formula 15 | 581 |
| Example 16 | Formula 16 | 589 |
| Comparative Example 1 | Formula 17 | 642 |
| Comparative Example 1 | Formula 18 | 589 |

As shown in table 2, etching speed of Example 2 to 16 is slower than that of Comparative Example 1, therefore etching tolerance of Example 2 to 16 is more excellent than that of Comparative Example 1. Also, the etching speed of Examples is more excellent or same in comparative to Comparative Example 2.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of reducing a size of contact holes, the method comprising:
coating a copolymer onto a photoresist layer with the contact holes, the copolymer being formed by a copolymerization a solution comprising a monomer with a norbornene functional group and two kinds of methacrylate monomers, each of the methacrylate monomers containing a different functional group coupled to an oxygen atom positioned at an end of the methacrylate monomer;
heating the copolymer which is coated on the photoresist layer with contact holes to reduce the size of the contact holes.

2. A water-soluble resin composition for forming fine patterns comprising:
a water-soluble polymer represented by Chemical Formula 1 as below and a first water-soluble solvent, the water-soluble resin composition being coated and heated on a photoresist layer having contact holes to reduce a size of the contact holes. 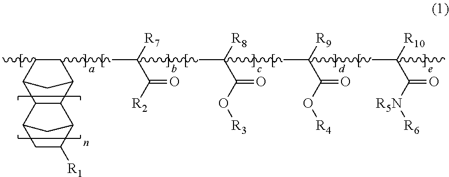
(In Chemical Formula 1,
each of R₁, R₂, R₃, R₄ and R₆ independently represents of a hydrogen atom, a hydroxyl group, a compound of C₁₋₃₀ or a cyclo compound of C₃₋₃₀ which respectively has one functional group selected from the group consisting of an ether group, an ester group, a carbonyl group, an acetal group, an epoxy group, a nitrile group, an amine group, and an aldehyde group (R₄≠R₄);
each of R₅, R₇, R₈, R₈ and R₁₀ independently represents a hydrogen atom or a methyl group;
n represents an integer of 0 to 5;
a represents a real number of 0.05 to 0.5;
each of b, c and d respectively represents a real number of 0 to 0.7; and
a+b+c+d+e=1)

3. The water-soluble resin composition of claim 2, wherein the water-soluble solvent comprises about 100 parts by weight of water and about 1 to about 20 parts by weight of an alcohol.

4. The water-soluble resin composition of claim 2, wherein the water-soluble resin composition comprise about 100 parts by weight of the water-soluble solvent and about 0.01 to about 15 parts by weight of the water-soluble polymer.

5. The water-soluble resin composition of claim 3, wherein the alcohol comprises an alkoxy alcohol.

6. The water-soluble resin composition of claim 2, wherein the water-soluble polymer has about 3,000 to about 50,000 of polystyrene-referenced weight-average molecular weight (Mw) by Gel-permeation chromatography (GPC).

7. The water-soluble resin composition of claim 6, wherein the water-soluble polymer has about 1.0 to about 5.0 of molecular weight distribution (weight-average molecular weight/number-average molecular weight).

8. A method of forming fine pattern comprising:
forming a photoresist layer;
forming a contact hole on the photoresist layer by photolithography method to prepare a photoresist pattern layer;
coating water-soluble resin composition of claim 2 on the photoresist pattern layer;
heat-treating the photoresist pattern layer coated by the water-soluble resin composition to form a coating layer having cross-linked part; and
applying the second water-soluble solvent to the coating layer for removing the coating layer except the cross-linked part.

9. The method of claim 8, wherein the second water-soluble solvent comprises water.

10. The method of claim 8, wherein the heat-treating of the photoresist pattern layer is performed at a temperature of about 100° C. to about 200° C.

11. The method of claim 8, wherein a size of the contact hole is adjusted to a temperature of the heat-treating.

12. The method of claim 8, wherein the photoresist layer includes norbornene derivatives, and the photoresist layer comprises a non-water-soluble layer.
